(19) United States
(12) Patent Application Publication
(10) Pub. No.: US 2006/0111494 A1
(43) Pub. Date: May 25, 2006

(54) Propylene glycol based latex material

(76) Inventor: Steven C. Cegelski, San Luis Obispo, CA (US)

Correspondence Address: DLA PIPER RUDNICK GRAY CARY US, LLP, 2000 UNIVERSITY AVENUE, E. PALO ALTO, CA, 94303-2248, US

(21) Appl. No.: 10/997,364

(22) Filed: Nov. 23, 2004

(51) Int. Cl. C08K 5/05

(52) U.S. Cl. 524/386

(57) ABSTRACT

A rubber composition containing propylene glycol is presented. The rubber composition contains a surfactant, propylene glycol, and any of natural rubber, synthetic rubber, or a mixture of natural and synthetic rubber. The rubber composition is freeze protected for temperature as low as −35° C. and may be used as a tire sealant, among other uses. The surfactant has an HLB level greater than 13. A method of making the rubber composition is also presented. The method entails adding propylene glycol to a surfactant to form a propylene glycol mixture, and combining the propylene glycol mixture with a rubber emulsion. Optionally, a fibrous or non-fibrous filler (e.g., cellulose fiber) may be added to the propylene glycol mixture prior to being combined with rubber. Also optionally, a tackifier and an antioxidant may be added to the rubber emulsion prior to being combined with the propylene glycol mixture.

### FIELD OF INVENTION

This invention relates generally to rubber latex material and particularly to freeze protected rubber latex material.

### BACKGROUND

Today, natural and synthetic rubber are widely used for various products such as clothing, gloves, eraser, tubing, etc. Depending on the application, the rubber product may be used in cold temperature or harsh weather. Thus, in some cases, a freeze protectant chemical is added to the rubber composition to ensure that the performance of the rubber product will not be compromised by environmental factors.

A popular freeze protectant chemical that is incorporated into rubber compositions is ethylene glycol. While there are other chemicals that would impart weather resistance to the rubber composition if mixed with rubber, ethylene glycol is preferred because of its compatibility with latex rubber. Ethylene glycol can be blended with rubber to generate a relatively smooth and usable freeze protected rubber composition. This compatibility with rubber distinguishes ethylene glycol from other freeze protective chemicals such as propylene glycol which, when blended with natural latex, triggers a process that results in coagulation and clumping. Thus, the mixture of propylene glycol and latex rubber does not lend itself to being used in products.

It is desirable to find an alternative freeze protectant chemical that is compatible with rubber. Alternatively, it is desirable to find a way to make the freeze protective chemicals that are currently not usable with rubber compatible with rubber.

### SUMMARY

In one aspect, the invention is a rubber composition including a latex rubber, a surfactant; and propylene glycol. The surfactant has a hydrophilic-lipophilic balance (HLB) level greater than 13. In another aspect, the invention is a method of making a rubber composition. The method entails adding propylene glycol to a surfactant to form a propylene glycol mixture, and combining the propylene glycol mixture with a rubber emulsion. The surfactant has an HLB level greater than 13. The rubber emulsion may contain natural rubber, synthetic rubber, or a combination thereof. The resulting rubber composition may be used for a tire sealant, although its utility is not so limited.

### BRIEF DESCRIPTION OF THE DRAWINGS

FIG. 1 is a flow chart of a process for making a propylene-glycol-based rubber composition.

FIG. 2 is a flow chart of an alternative process for making a propylene-glycol-based rubber composition.

### DETAILED DESCRIPTION OF THE PREFERRED EMBODIMENT(S)

Embodiments of the invention are described herein in the context of tire sealant. However, it is to be understood that the embodiments provided herein are just preferred embodiments, and the scope of the invention is not limited to the applications or the embodiments disclosed herein. For example, the invention may be adapted for other types of applications that would benefit from a rubber material with freeze protection. Further, the invention may be adapted for other types of chemicals that are not compatible with rubber by itself.

The invention includes a propylene glycol-based latex rubber composition. The propylene glycol-based latex rubber composition is environmentally friendly, water soluble, and provides thermal freeze protection at a temperature as low as −31° F. (−35° C.). Moreover, the rubber composition is substantially less toxic than its ethylene glycol based counterpart. This invention further includes utilizing a non-ionic surfactant to combine propylene glycol with rubber without coagulation or clumping. A “surfactant,” as used herein, refers to a substance that reduces the surface tension of the liquid in which it is dissolved. The surfactant may be a branched or linear form of ethylene oxy, which usually comes in the form of a waxy solid. The formulation of the invention is based on a discovery that a surfactant with a high hydrophilic-lipophilic balance (HLB) level allows for the successful interfacing of the propylene glycol and latex. HLB is an empirical expression for the relationship between the hydrophilic and hydrophobic groups of a surfactant. According to the invention, using a surfactant with an HLB level that is above 13, and more preferably above 17, is conducive to forming a stable and homogeneous combination of propylene glycol (PG) and latex. A stable and homogeneous PG-latex mixture may be difficult to form using a surfactant with an HLB level lower than 13.

Unlike most ethylene glycol based rubber compositions, which use natural latex rubber, the propylene glycol based rubber composition may be prepared with natural rubber, synthetic rubber, or a mixture of natural rubber and synthetic rubber. A mixture containing natural rubber and/or synthetic rubber is herein referred to as a “rubber emulsion.” Where the rubber emulsion contains both natural rubber and synthetic rubber, the ratio of natural to synthetic rubber may be between about 1:100 and 100:1.

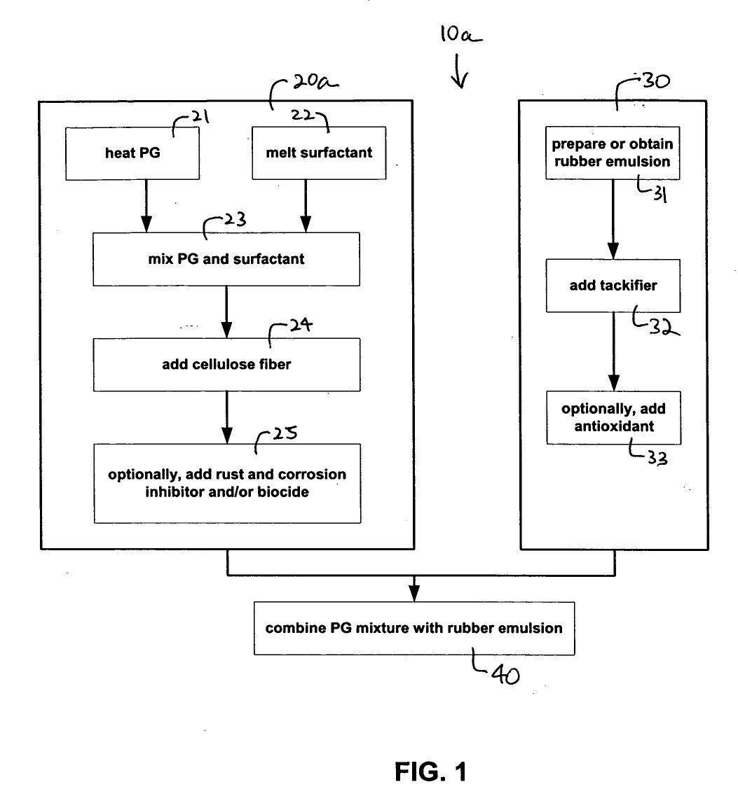

FIG. 1 is a flowchart of a process 10a for preparing the propylene glycol-based rubber composition. The process 10a entails a propylene glycol subprocess 20a whereby a PG mixture is prepared, a rubber emulsion subprocess 30 whereby a rubber emulsion is prepared, and the combination process 40. During the combination process 40, the PG mixture and the rubber emulsion are combined.

The propylene glycol subprocess 20a begins by heating the propylene glycol to a temperature between 100° F. and 200° F., preferably between 130° F. and 170° F. (step 21). The surfactant, which is usually a waxy solid at room temperature, is also heated to a temperature above its melting point (step 22) to facilitate the mixing with propylene glycol. The heated PG and the molten surfactant are then mixed (step 23) to form a PG mixture. The surfactant and PG are combined in a surfactant:PG weight ratio of about 1:1000 to 1:10, preferably about 2:100 to 4:100. While it is preferable for the surfactant to constitute no more than about 2 wt. % of the PG mixture, the surfactant constitutes a relatively small weight fraction of the PG mixture. The surfactant may be, for example, ethylene oxy.

Optionally, a filler material such as cellulose fiber may be added to the PG mixture (step 24). Addition of cellulose fiber is especially advantageous if the end rubber composition is to be used for a tire sealant. Currently, introducing cellulose fibers to the sealants is challenging because the presence of the cellulose fibers interferes with the injection of the sealant through the tire valve core. Fibers and non-fibrous filler material that act as clotting agents contribute to the effectiveness of the rubber composition when used in the sealant. In conventional sealants, cellulose fibers and other fillers are introduced into a tire separately, during the tire fitting process. In accordance with the invention, however, the cellulose fiber and other filler material are sized to pass through the tire valve core. The size of the valve core opening without the valve core generally ranges from about 2 mm to about 4 mm. With the valve core removed, larger sized fibers and various filler materials may readily pass through when in solution. However, when the valve core is in place, only certain sized fibers and filler materials may pass through the valve stem.

The invention may include an installation tube that depresses or engages the valve core and allows the sealant material to pass through along with the fibers. The opening of the depressed valve core ranges from 0.25 mm to 1.75 mm depending on the type of valve utilized. By being sized down to a dimension that is smaller than the dimension of the air passage in the valve core, the cellulose fiber and filler material may be directly added to the rubber composition and not interfere with the injection process.

To ensure smooth injection of the rubber composition through the valve, the length of the cellulose fiber is preferably between about 20 and 140 microns, and more preferably between about 30 and 60 microns. About 2-200 g of cellulose fiber is added for about every 1000 mL of the propylene glycol mixture. In the resulting rubber composition, the weight fraction of cellulose fiber ranges from 1-10. The diameter of the added fibers and/or filler material does not exceed the diameter of the particular depressed or engaged valve core type. In one embodiment, the weight fraction of a fibrous filler material is less than 3% of the weight of the rubber composition and the fibrous filler material has a diameter less than about 200 microns and a length between about 20 and about 140 microns. In another embodiment, the fibrous filler material constitutes less than 10% of the weight of the rubber composition, has a diameter less than 250 microns, and a length between about 30 and about 60 microns.

Optionally, rust and corrosion inhibitors and biocides may be added to the propylene glycol mixture (step 25). 2-mecaptobenzothiazol is an exemplary inhibitor that may be used for the process 10a. Grotan is an exemplary biocide that may be used for the process 10. Any inhibitor or biocide that a person of ordinary skill in thwart deems suitable may be used.

In the rubber emulsion subprocess 30, the rubber emulsion is prepared by any well known method (step 31). As stated above, the rubber emulsion may contain natural rubber, synthetic rubber, or a combination thereof. A nonexhaustive list of suitable synthetic rubber includes styrene butadiene, acryl nitrile butadiene, ethylenevinylacetate, chloroprene, vinylpyridene, and butyl rubber. An adhesive tackifier may also be added (step 32). The tackifier may be a hydrocarbon resin such as a rosin ester system that is compatible with the latex lattice of the rubber. The tackifier dispersion is high in solid content and water-soluble. The weight ratio of the tackifier to the natural rubber is less than 1:5 and preferably between about 1:20 and about 1:5. Preferably, the weight ratio of tackifier to rubber is about 1:4.6. Where the rubber emulsion includes both natural rubber and synthetic rubber, the weight ratio of the natural rubber plus the tackifier to the rubber emulsion is less than about 1:5 and preferably between about 1:7 to about 1:5 (e.g., about 1:6.6).

Optionally, antioxidants may be added to the rubber composition (step 33). Also optionally, a thinning agent may be used. Antioxidants protect against the effects of heat, light, and oxidation that may occur over time. A phenolic type antioxidant is preferred. An exemplary antioxidant would be Akrosperse W-2294 made by Akrochem Chemical in Ohio.

In the combination process 40, the propylene glycol mixture and the rubber emulsion are combined. In the final mixture, the weight fraction of propylene glycol is between about 10% and 60% relative to the weight of the total mixture. For optimal freeze protection, it is preferable for the weight fraction of propylene glycol to be between about 20% and about 40%. The weight fraction of the rubber emulsion solids can range from about 20% to about 60%, and is preferably between about 30% and about 50%.

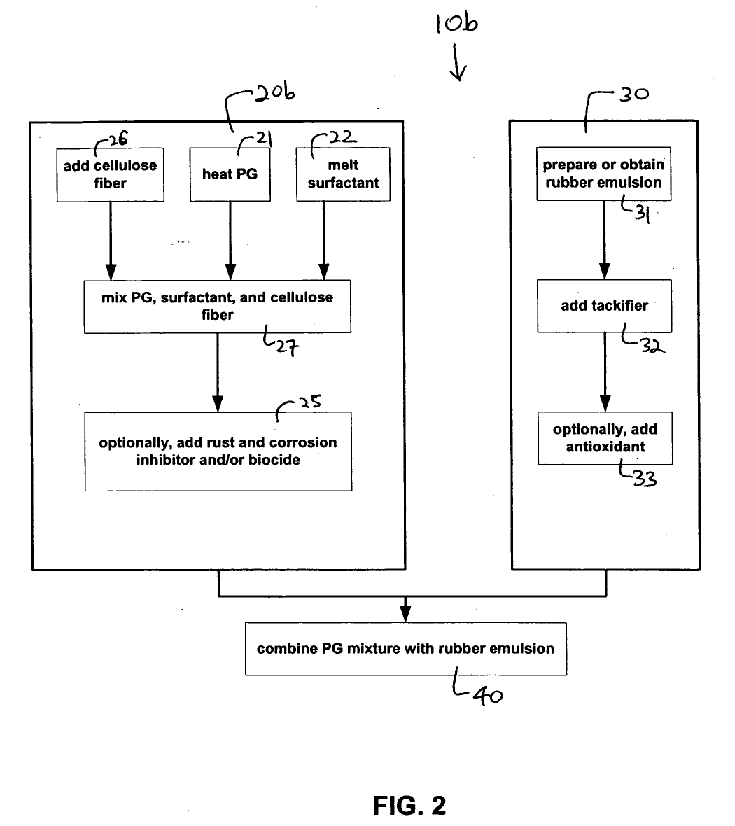

FIG. 2 is a flowchart of an alternative process 10b for preparing the propylene glycol-based rubber composition. The process 10b is similar to the process 10a of FIG. 1, with the main difference being the use of a propylene glycol subprocess 20b instead of the propylene glycol subprocess 20a. The rubber emulsion subprocess 30 and the combination process 40 are substantially similar to the subprocesses in FIG. 1.

In the propylene glycol subprocess 20b, the propylene glycol is heated (step 21) and the surfactant is molten (step 22). The cellulose fiber is prepared for addition (step 26). Unlike in the process 10a, the cellulose fiber, the heated propylene glycol, and the molten surfactant are combined at once (step 27) instead of the cellulose fiber being added at a later stage. Due to the addition of cellulose fiber, propylene glycol, and high-HLB surfactant in the same step, the “PG mixture” of the alternative process 10b contains cellulose fiber unlike the PG mixture of the process 10a.

The latex rubber composition may be used in tire sealants. One of the conventional ways of using such tire sealants is by placing them in a can with a pressurized gas (e.g., a propane/butane mixture). When a tire puncture occurs, the sealant is sprayed from the pressurized can into the interior of the tire through the tire valve. At the same time, the tire is inflated by means of the propellant gas. The inflated tire is then driven to distribute the sealant on the inner walls of the tire, thereby sealing the puncture. There are other methods of applying the sealant to fix a defect in a tire, and most of them may be used with the propylene glycol-based rubber composition disclosed herein.

An advantage of a tire sealant made in accordance with the invention is that cellulose fiber or other filler material does not have to be introduced into the tire during fitting as a separate step. The cellulose fiber or the filler material can be directly added to the propylene glycol-based rubber composition, as described above, by sizing the cellulose fiber to pass through the tire valve stem. With the sealant containing small cellulose fibers or filler material, the sealant can be injected into the tire through a plastic filler tube or hose that is engaged to the tire valve. In many cases, the valve core can be removed, allowing for an easy flow of sealant through the valve core and into the tire. Some connectors can be attached to the filler hose that allow for the valve core to remain in place. The connector depresses the valve, thereby allowing the sealant to flow into the tire without removing the valve core. When adding the sealant without removing the valve core, additional pressure may be needed. This additional pressure may be supplied by compressed air or gas, as in the connector system used in the commercially available “Fix a Flat” manufactured by Pennzoil/Quaker State. The “Fix a Flat” system, which uses an aerosol delivery unlike the sealant disclosed herein, relies on compressed gas incorporated into a pressurized can. The compressed gas is combined with a sealant solution in the pressurized can. Unlike the sealant in the “Fix a Flat” system, the sealant described herein can be injected into a tire manually via a squeeze bottle or automatically by applying air pressure from an appropriate air source to the sealant in a separate bottle that is connected to the air source. In some embodiments, the sealant is blended with the compressed gas into a canister.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention.

What is claimed is:

1. A rubber composition comprising:
a latex rubber;
a surfactant having a hydrophilic-lipophilic balance level greater than 13; and
propylene glycol.

2. The composition of claim 1, wherein propylene glycol constitutes about 10% to 60% of the composition by weight.

3. The composition of claim 1, wherein the weight ratio of propylene glycol to the surfactant is between about 1:1000 to 1:10, inclusive.

4. The composition of claim 1, wherein the latex rubber comprises at least one of a natural rubber and a synthetic rubber and wherein the ratio of natural rubber to synthetic rubber is between about 1:100 and 100:1.

5. The composition of claim 1, wherein the latex rubber comprises at least one of a natural rubber and a synthetic rubber and the synthetic rubber includes one or more of styrene butadiene, acrylo nitrile butadiene, ethylenevinylacetate, chloroprene, vinylpyridene, and butyl rubber.

6. The composition of claim 1, wherein the fraction of latex rubber is between about 20% and 60% by weight.

7. The composition of claim 1 further comprising a tackifier.

8. The composition of claim 7, wherein the latex rubber includes a natural rubber, and a weight ratio of the tackifier to the natural rubber is less than 1:5.

9. The composition of claim 7, wherein the latex rubber includes a natural rubber, and a weight ratio of the tackifier to the natural rubber is between about 1:20 and about 1:5.

10. The composition of claim 7, wherein the latex rubber includes a natural rubber and a synthetic rubber, and a weight ratio of a combination of the natural rubber and the tackifier to the latex rubber is less than about 1:5.

11. The composition of claim 7, wherein the ratio is between about 1:5 and about 1:7.

12. The composition of claim 7, wherein the tackifier is a hydrocarbon resin.

13. The composition of claim 1 further comprising a fibrous filler material.

14. The composition of claim 13, wherein a weight fraction of the fibrous filler material is less than 10% of the weight of the rubber composition.

15. The composition of claim 14, wherein a single one of the fibrous filler material has a length between about 20 and 140 microns.

16. The composition of claim 15, wherein the single one of the fibrous filler material has a diameter less than 200 microns.

17. The composition of claim 13, wherein a single one of the fibrous filler material has a length between about 30 and 60 microns.

18. The composition of claim 17, wherein the single one of the fibrous filler material has a diameter less than about 250 microns.

19. The composition of claim 18, wherein a weight of the fibrous filler material is less than 10% of a weight of the rubber composition.

20. The composition of claim 1, wherein the surfactant is ethylene oxy.

21. The composition of claim 1 further comprising a non-fibrous filler material.

22. The composition of claim 1 further comprising at least one of rust and corrosion inhibitor, a biocide, and a phenolic-type antioxidant.

23. A method of forming a rubber composition, the method comprising:
adding propylene glycol to a surfactant having an HLB level above 13 to form a propylene glycol mixture; and
combining the propylene glycol mixture with a rubber emulsion.

24. The method of claim 23, wherein the propylene glycol is added to achieve a surfactant to propylene glycol ratio that is between about 1:1000 and 1:10 by weight.

25. The method of claim 23, wherein the propylene glycol is added to achieve a surfactant to propylene glycol ratio between about 2:100 and 4:100 by weight.

26. The method of claim 23, wherein the mixture is combined with the rubber emulsion to achieve a propylene glycol fraction of 10% to 50% by weight.

27. The method of claim 23, wherein the mixture is combined with the rubber emulsion to achieve a solid rubber weight fraction of between about 20% to about 60%.

28. The method of claim 23 further comprising adding a fibrous filler material to the mixture before combining the propylene glycol mixture with the rubber emulsion.

29. The method of claim 23 further comprising adding an adhesive tackifier to the mixture.

30. The method of claim 23 further comprising adding an adhesive tackifier to the rubber emulsion before combining with the propylene glycol.

31. The method claim 23, wherein the rubber emulsion comprises natural rubber and synthetic rubber.

32. The method of claim 23 further comprising adding a fibrous filler material to the propylene glycol mixture.

33. The method of claim 23 further comprising adding about 2 grams to about 200 grams of a cellulose fiber to about 1000 mL of the propylene glycol mixture.
